(19) United States
(12) Patent Application Publication
(10) Pub. No.: US 2003/0183251 A1
(43) Pub. Date: Oct. 2, 2003

(54) Process for drying an object having microstructure and the object obtained by the same

(75) Inventors: Nobuyuki Kawakami, Kobe-shi (JP); Kohei Suzuki, Kobe-shi (JP); Katsuyuki Iijima, Kobe-shi (JP); Takeharu Tanaka, Kobe-shi (JP); Yoshiyuki Nagase, Kobe-shi (JP); Kaoru Masuda, Kobe-shi (JP); Masahiro Yamagata, Takasago-shi (JP)

Correspondence Address: REED SMITH LLP, Suite 1400, 3110 Fairview Park Drive, Falls Church, VA, 22042, US

(73) Assignee: Kabushiski Kaisha Kobe Seiko Sho

(21) Appl. No.: 10/401,610

(22) Filed: Mar. 31, 2003

Related U.S. Application Data
(63) Continuation-in-part of application No. 10/126,782, filed on Apr. 22, 2002.

(30) Foreign Application Priority Data
Apr. 24, 2001 (JP) 2001-126618
Dec. 10, 2001 (JP) 2001-376319

(51) Int. Cl. B08B 3/00

(52) U.S. Cl. 134/34; 134/29; 134/30

(57) ABSTRACT

Disclosed is a drying method constituted such that, in a case of including the cleaning step using the water-containing solvent, substituting a water on a microstructure by a fluorocarbon type solvent having the water substitution solvent proper value X of from 0.01 to 10 defined by the formula (1) and further substituting by a fluorocarbon type solvent which may be identical with or different from the fluorocarbon type solvent described above, enabling steps up to the drying with liquefied/critical carbon dioxide to be conducted rapidly and to prevent collapse or swell of a photoresist pattern.

### BACKGROUND OF THE INVENTION AND RELATED ART STATEMENT

1. Field of the Invention

The present invention relates to a process for drying such an object that has a microstructure and has fine unevenness on its surface as that of a semiconductor substrate. Specifically the invention relates to the process for drying the fine pattern of the object without swell and/or collapse, by employing liquefied carbon dioxide or supercritical carbon dioxide.

2. Description of the Related Art

There is a known process disclosed in JP-A No. 223467/2000 that, when forming a pattern using a photoresist during a semiconductor production process, rinses a substrate after development into alcoholic solvent such as isopropanol (IPA), and dries the same by employing liquefied or supercritical carbon dioxide at low viscosity. The reason for employing the carbon dioxide at a supercritical state having low viscosity for the removal of the rinsing liquid and for drying of the substrate is that an conventional process employing organic solvents involves a problem; upon drying a rinsing liquid, convex portions of the pattern are collapsed due to the capillary force exerted on the gas/liquid boundary or volumic expansion caused by heating upon drying.

Under the circumstances where pattern has been refined to a level of 100 nm or less, aspect ratio of the pattern has been increased rapidly (that has larger height compared with width), and a demand for the dimensional accuracy of the pattern has also become severer gradually than before.

Further there may be a case where the substrate is cleaned, not through said steps of rinsing by IPA then drying by liquefied and/or supercritical carbon dioxide, but through the steps of rinsing by super pure water, an aqueous solution containing surfactant or a solvent containing a trace amount of water (referred to as “water-containing solvent”, hereinafter) after the development, for example, alkaline development. The conventional process that has steps of rinsing by water-containing solvent, then drying by liquefied and/or supercritical carbon dioxide can no longer cope with preventing swell and/or collapse of the fine pattern with such the high aspect ratio. So, a method of drying the microstructure brought into contact with, e.g., cleaned by or rinsed by, the water-containing solvent, with no problem of swell and/or collapse of the pattern has also been demanded.

### SUMMARY OF THE INVENTION

In view of the foregoings, this invention aims at providing a drying method with no swell or the like of the pattern upon drying a microstructure such as a semiconductor substrate after the development with liquefied or supercritical carbon dioxide after the steps of bringing the microstructure into contact with water-containing solvent, e.g., rinsing or cleaning by water-containing solvent.

In a first aspect according to the present invention, a method of drying a microstructure with liquefied carbon dioxide or supercritical carbon dioxide comprises the steps of:

bringing the microstructure into contact with a water-containing solvent,

substituting the water on the microstructure by a fluorocarbon type solvent having a water substitution solvent proper value X of from 0.01 to 10 defined by the following formula (1), and

bringing the microstructure into contact with liquefied carbon dioxide or supercritical carbon dioxide in a state where the microstructure is covered with the fluorocarbon type solvent which may be identical with or different from the fluorocarbon type solvent described above:

$$X = \frac{\begin{matrix}( total weight of hydrophilic portion \\ contained in functional group {R}_{x} )\end{matrix}}{( weight of fluorocarbon type solvent )} \times 100$$

[where Rₓ is one or more member selected from —OH group,

—COOH group, —NH₂ group, —C═O group and a polyethylene ether group represented by —(CH₂CH₂—O)ₙ—, in which the hydrophilic portion is OH in the —OH group, OOH in the —COOH group, NH₂ in the —NH₂ group, O in the —C—O group, and (CH₂CH₂—O)ₙ in the polyethylene ether group represented by —(CH₂CH₂—O)ₙ—] (1)

Swelling of a pattern can be suppressed as much as possible by substituting water after cleaning with a fluorocarbon type solvent having the water substitution solvent proper value X of from 0.01 to 10 defined by the formula (1) described above.

### DETAILED DESCRIPTION OF THE PREFERRED EMBODIMENTS

In a second aspect defined in the first aspect of drying method according to the present invention, after substituting water on the microstructure by the fluorocarbon type solvent, the microstructure is brought into contact with liquefied carbon dioxide or supercritical carbon dioxide in a state where the surface of the microstructure is covered as it is with the fluorocarbon type solvent substituting water.

In another preferred embodiment, a compound having an etheric bond in the molecule and/or hydrofluorocarbon is used as an entire portion or a portion of the fluorocarbon type solvent, by which the effect of suppressing the collapse of the pattern is further improved.

In another preferred embodiment, the fluorocarbon type solvent comprises a fluorinated alcohol represented by the general formula: H—(CF₂)ₙ—CH₂OH, which can provide an exellent drying while suppressing the collapse of the pattern.

This invention also includes a microstructure obtained by the drying method described above.

The object of the drying method according to this invention is a microstructure, e.g., formed with fine unevenness such as a semiconductor substrate after development of photoresist. Further, this invention is also usable as a drying method for forming a clean dry surface on metals, plastics and ceramics.

The present inventors have studied a method free from swelling and collapse of a pattern even in a case of bringing the microstructure into contact (including rinsing and cleaning here and hereinafter) with water-containing solvent such as super pure water after development, and then conducting drying with liquefied/supercritical carbon dioxide. In a case of cleaning with a water-containing solvent after development, for example, in alkaline development, most of photoresist materials employed are basically hydrophilic materials and solvents having a number of polar groups as functional groups exhibit excess affinity with the photoresist to result in a problem of dissolving the photoresist. Further, since a fluorocarbon type solvent which is extremely suitable to drying with liquefied/supercritical carbon dioxide after rinsing with IPA or the like after development is less miscible with water, when the step of covering the surface of the microstructure with a fluorocarbon type solvent is conducted just after the cleaning or rinsing step with water, it results in a problem that water remains on the surface of the microstructure failing to prevent swelling and collapse of the pattern. Further, when water is substituted with a liquid mixture formed by mixing the fluorocarbon type solvent with a hydrophilic alcoholic solvent (not having fluorine atom), this results in a problem that the photoresist pattern is dissolved.

In view of the above, in the present invention, the microstructure is dried upon drying the microstructure with liquefied carbon dioxide or supercritical carbon dioxide, by a method including the steps of:

bringing the microstructure into contact with a water-containing solvent,

substituting the water on the microstructure by a fluorocarbon type solvent having a water substitution solvent proper value X of from 0.01 to 10 defined by the following formula (1), and

bringing the microstructure into contact with liquefied carbon dioxide or supercritical carbon dioxide in a state where the microstructure is covered with the fluorocarbon type solvent which may be identical with or different from the fluorocarbon type solvent described above:

$$X = \frac{\begin{matrix}( total weight of hydrophilic portion \\ contained in functional group {R}_{x} )\end{matrix}}{( weight of fluorocarbon type solvent )} \times 100$$

[where Rₓ is one or more member selected from —OH group,

—COOH group, —NH₂ group, —C═O group and a polyethylene ether group represented by —(CH₂CH₂—O)ₙ—, in which the hydrophilic portion is OH in the —OH group, OOH in the —COOH group, NH₂ in the —NH₂ group, O in the —C—O group, and (CH₂CH₂—O)ₙ in the polyethylene ether group represented by —(CH₂CH₂—O)ₙ—] (1)

Most of photoresist materials basically include hydrophilic materials and solvents having a number of polar groups as functional groups exhibit excess affinity with the photoresist to dissolve the photoresist. The polar group having an effect on the affinity to the photoresist is a functional group Rₓ represented by the formula (1) described above. Since the attacking mechanism of the solvent to the photoresist is considered to be a surface reaction, it is considered that the proportion of the surface area of the hydrophilic portion of the functional group Rₓ of the formula (1) in the molecule has a concern with attack to the photoresist. Further, since the solvent is used for substituting water, it is not necessary that the solvent is dissolved in water but some affinity with water is necessary. Therefore, among the fluorocarbon type solvents, when a solvent having the water substitution solvent proper value X of from 0.01 to 10 defined by the formula (1) is used for substituting water, drying can be attained with no swelling or collapse of the pattern.

In the step of covering the surface of the microstructure after the step of substituting water, the surface of the microstructure may be covered with another fluorocarbon type solvent, or the surface of the microstructure may be covered as it is without removing the solvent after substitution of water. However, it is preferred that the microstructure is brought into contact with liquefied carbon dioxide or supercritical carbon dioxide in a state covering the surface of the microstructure without removing the solvent after substitution of water by the following reasons.

That is, decrease in the number of steps in the drying treatment of the microstructure is extremely important in view of the cost and the facility, and a great advantage can be provided if drying can be conducted with liquefied carbon dioxide or supercritical carbon dioxide while covering the surface of the microstructure as it is with the water substituting solvent, without replacing the solvent for substituting water with a solvent suitable to the step of bringing into contact with liquefied carbon dioxide or supercritical carbon dioxide. Accordingly, the method of the present invention capable of drying with no swelling and collapse of the pattern even when conducting the step of bringing the surface of the microstructure into contact with liquefied carbon dioxide or supercritical carbon dioxide while covering the surface of the microstructure as it is without removing the water substituting solvent is excellent.

Specifically, drying is completed as follows. The microstructure, immersed in a fluorocarbon type solvent having the water substitution solvent proper value X of from 0.01 to 10 defined by the formula (1) under an atmospheric pressure, is charged into a chamber capable of applying high pressure treatment in a state where the surface thereof is covered with fluorocarbon type solvent which is identical with or different from the fluorocarbon type solvent described above. Then the liquefied carbon dioxide or supercritical carbon dioxide is caused to flow in the chamber, removing the fluorocarbon type solvent from the surface of the microstructure. After that, the chamber is depressurized to thereby cause the liquefied and/or supercritical carbon dioxide to be evaporated from the surface of the microstructure.

The method of covering the surface of the microstructure with the fluorocarbon type solvent includes not only immersion into the fluorocarbon type solvent but also dripping a fluorocarbon type solvent like a shower from above while removing other solvent from the surface by rotating the microstructure in the case where other solvent is deposited to the microstructure for instance.

As the fluorocarbon type solvent having the water substitution solvent proper value X of from 0.01 to 10 defined by the formula (1), hydrofluoro ethers, hydrofluoro carbons, fluorinated alcohols represented by the general formula: H—(CH₂)ₙ—CH₂OH, and FLUORINATES (registered trademark) manufactured by Sumitomo Three M Co. can be used alone or as a mixture of two or more of them.

The water substitution solvent proper value X in the mixed solution is defined as a weight ratio of a hydrophilic portion of the functional group Rₓ represented by the formula (1) described above contained in the mixed solution.

The hydrofluoro ethers can include, e.g., C₄F₉OCH₃ (e.g., “HFE7100” manufactured by Sumitomo Three M Co.), and C₄F₉OC₂H₅ (e.g., “HFE7200”, manufactured by Sumitomo Three M Co. and the like.

The hydrofluorocarbons include, e.g., CF₃CHFCHFCF₂CF₃ (e.g., “Vertrel” manufactured by DuPont Co.). Further, the FLUORINATE series includes, e.g., “FC-40”, “FC-43”, “FC-70”, “FC-72”, “FC-75”, “FC-77”, “FC-84”, “FC-87”, “FC-3283” and “FC-5312”.

When n in H—(CF₂)ₙ—CH₂OH of the general formula for the fluorinated alcohol is 2 to 6, it has more affinity with water remaining in the inside of the pattern and can effectively substitute water and, in addition, it is also excellent in the solubility to carbon dioxide, so that it does not remain in the inside of the pattern in the drying step, which is preferred.

Although the immersion time of the microstructure in the fluorocarbon type solvent has no particular restriction, it may be sufficiently from 10 sec to several minutes. Further, after the development of the photoresist, the microstructure is rinsed with a water-containing solvent.

The liquefied carbon dioxide that can be used for drying in this invention is carbon dioxide pressurized to 5 MPa or more and it may be formed into supercritical carbon dioxide by setting to 31° C. or higher and 7.1 MPa or more. Pressure in the drying step is preferably 5 to 30 MPa and, more preferably, 7.1 to 20 MPa. The temperature is preferably from 31 to 120° C. When it is lower than 31° C., since the fluorocarbon type solvent is less dissolved to carbon dioxide, it takes much time for removing the fluorocarbon type solvent from the surface of the microstructure to lower the efficiency of the drying step. However, even when it exceeds 120° C., no further improved is observed for the drying efficiency and, in addition, it is disadvantageous in view of energy. The time required for drying may be changed optionally in accordance with the dimension of the object or the like and it may be about from several minutes to several tens minutes.

After the completion of the high pressure treatment, since carbon dioxide is rapidly gasified and evaporated by returning the pressure in the chamber to an atmospheric pressure, drying is completed with no destruction of the fine pattern of the microstructure. It is preferred that carbon dioxide in the chamber before depressurization is in a supercritical state. Since it can be depressurized to an atmospheric pressure by way of only the gas phase, pattern collapse can be prevented.

There is no particular restriction on the cleaning or rinsing step with the water-containing solvent and, for example, a method of immersing the microstructure into the water-containing solvent or a method of dripping the solvent in a shower form while rotating the microstructure can be adopted, and the step of substitution by the fluorocarbon type solvent having the water substitution solvent proper value X of from 0.01 to 10 defined by the formula (1) described above may be conducted also by the similar method. The water-containing solvent can include super pure water or pure water itself, water containing a surfactant and an organic solvent in which water is mixed (if in a trace amount). After completion of the substitution step for the water-containing solvent with a fluorocarbon type solvent having the water substitution solvent proper value X of from 0.01 to 10 defined by the formula (1), the surface of the microstructure is covered with the fluorocarbon type solvent and dried by liquefied/supercritical carbon dioxide as described above to complete the drying method according to the present invention.

### EXPERIMENTS

This invention is to be described more specifically by way of examples but the following examples do not restrict the invention, and any modification within a range not departing the gist to be described later is included within the technical range of the invention. Unless otherwise specified, “parts” means “mass parts” and “%” means “mass%”.

### Experiment 1

Photoresist “Uv2” manufactured by Shipley Co. was coated at on a Si wafer a number of rotation number of 3000 rpm to form a photoresist film of 4000 Å thickness. Successively, after prebaking at 130° C. for 90 sec, patterning was conducted by electron beam exposure (electron beam acceleration: 50 kev: electron dose 10 μC/cm²). Further, baking was conducted at 140° C. for 90 sec. The wafer formed with the exposed photoresist film was subjected to a developing treatment for one minute using a liquid developer (aqueous solution of 2.38% tetramethyl ammonium hydroxide).

After development, super pure water was supplied to the wafer surface while rotating the wafer to or flush away the liquid developer. Test solutions shown in Table 1 was supplied while rotating the wafer without drying the wafer surface and super pure water was completely removed from the wafer surface. Successively, a fluorocarbon type solvent “FC-40” (manufactured by Sumitomo Three M Co.) was supplied to the surface while rotating the wafer without drying the wafer surface to completely substitute test solutions for “FC-40”. Rotation of the wafer was stopped and about 10 ml of “FC-40” was additionally supplied to the wafer surface so that the surface was not dried after stopping of the wafer rotation.

The wafer formed with the photoresist film was introduced into a chamber capable of supercritical treatment while being kept in a state where the surface was covered with “FC-40”. While supplying carbon dioxide previously heated to 50° C. by a liquid supply pump to the chamber kept at 50° C., carbon dioxide in the chamber was adjusted to 8 MPa by a pressure control valve, to bring the inside of the chamber into a supercritical state of carbon dioxide. By the flow of the supercritical carbon dioxide through the chamber, “FC-40” was removed out of the chamber to substitute the inside of the chamber only for supercritical carbon dioxide. Subsequently, the pressure in the chamber was depressurized to an atmospheric pressure while maintaining the chamber at 50° C. to dry the wafer having the photoresist film. The photoresist pattern was observed under an electron microscope to observe the absence or presence of pattern collapse or pattern swell. The result of the observation is shown in Table 1. “-” in the table indicates that there were no pattern collapse or pattern swell. “±” in the table indicates the presence of some pattern swell. Further, the water drainability and the photoresist dissolution were evaluated before substituting “FC-40” for supercritical carbon dioxide. For the water drainability, the pattern in a state covered with “FC-40” was observed under an optical microscope to evaluate the absence or presence of water droplets. In the table, water drainability “excellent” indicates that water droplets were not observed at all. Water drainability “Fair” in the table indicates that some water droplets were observed. Photoresist dissolution was evaluated by measuring the thickness of the photoresist film before and after coating the water draining liquid with an ellipsometer. Photoresist dissolution “-” in the table indicates that the thickness did not change.

TABLE 1

| | | | Water | | | | |
|---|---|---|---|---|---|---|---|
| | | | substitution | | | | |
| Exp. | | | solvent proper | Water | Photoresist | Pattern | Pattern |
| No. | Solution | | value X | drainability | dissolution | collapse | swell |
| 3-1 | HFE7200 (95%) | Perfluoro isopropanol (5%) | 0.46 | Exellent | − | − | − |
| 3-2 | HFE7200 (90%) | Fluorinated carboxylic | 1.3 | Exellent | − | − | − |
| | | acid (10%) | | | | | |
| 3-3 | HFE7200 (99%) | Trifluoro ethanol (1%) | 0.17 | Fair | − | − | ± |
| 3-4 | Vertrel | Perfluoro propanol (5%) | 0.46 | Excellent | − | − | − |
| | XF (95%) | | | | | | |
| 3-5 | Vertrel | Fluorinated carboxylic | 1.3 | Excellent | − | − | − |
| | XF (90%) | acid (10%) | | | | | |
| 3-6 | Vertrel | Trifluoro ethanol (1%) | 0.17 | Fair | − | − | ± |
| | XF (99%) | | | | | | |

* HFE7200: C₄F₉OC₂H₅
* Vertrel XE: CF₃CHFCHFCF₂CF₃

### Experiment 2

Development and cleaning by super pure water after the development were conducted in the same manner as in Experiment 1 and the wafer surface was dried after cleaning merely by a spin drying method. When the photoresist pattern was observed under SEM, fine pattern was entirely collapsed.

### Experiment 3

Photoresist UV2 manufactured by Shipley Co. was spin coated on the silicon wafer under the number of rotation of 3000 rpm to formaphotoresist film of 4000 Å thickness. Successively, after prebaking at 130° C. for 90 sec, patterning was conducted by electron beam exposure. Successively, baking after exposure was conducted at 140° C. for 90 sec and a developing treatment was conducted for one minute using a liquid developer (aqueous solution of 2.38% tetramethyl ammonium hydroxide). The liquid developer was flushed away by a method of supplying super pure water to the photoresist surface while rotating the wafer after the development to conduct rinsing.

After rinsing the wafer after the development by super pure water, the super pure water was substituted for a fluorinated alcohol (H—(CF₂)₄—CH₂OH, water substitution solvent proper value X: 7.3). After substitution, the wafer was introduced into a chamber capable of high pressure treatment in a state where the fluorinated alcohol covered the wafer surface. Subsequently, carbon dioxide heated to 40° C. was supplied by a pump to pressurize the inside of the chamber to 15 MPaG and carbon dioxide was supplied continuously to dry the fluorinated alcohol. After the drying, the pressure was released and the wafer was observed under an electron microscope. It was confirmed that 70 nm line & space, and dot pattern were maintained with no collapse. Further, swell of the photoresist was not observed in each of the pattern.

Further, as a comparative experiment, a sample formed by development and cleaning by super pure water and then drying rapidly by a spin drying method after rinsing not by way of the above-mentioned supercritical drying step was also prepared. The sample was observed by SEM. It was observed that 70 nm line & space, and dot pattern were entirely collapsed.

### Experiment 4

Photoresist “UV2” manufactured by Shipley Co. was spin coated on a Si wafer at a number of rotation of 3000 rpm to form a photoresist film of 4000 Å thickness. Successively, after prebaking at 130° C. for 90 sec, patterning was conducted by electron beam exposure (electron beam acceleration; 50 kev, electron dose : 10 μC/cm²). Further, baking was conducted at 140° C. for 90 sec. The wafer formed with the exposed photoresist film was put to a developing treatment for 1 minute by using a liquid developer (aqueous solution of 2.38% tetramethyl ammonium hydroxide).

After the development, super pure water was supplied to the wafer surface while rotating the wafer to flush away the liquid developer. Without drying the wafer surface, a fluorinated alcohol (H—(CF₂)₆—CH₂OH) was supplied while rotating the wafer to completely remove super pure water from the wafer surface and to completely substitute for fluorinated alcohol (H—(CF₂)₆—CH₂OH, water substitution solvent proper value X: 5.1). After the rotation of the wafer was stopped, additional fluorinated alcohol was supplied by about 10 ml to the wafer surface so that the wafer surface would not dry after the stopping of the wafer.

The wafer formed with the photoresist film was introduced into a chamber capable of supercritical treatment in a state where the surface was covered with the fluorinated alcohol. Then, carbon dioxide previously heated to 50° C., and the pressure of carbon dioxide was controlled to 8HPa by a control valve to obtain a spercritical state. By flowing the supercritical carbon dioxide through the chamber, the fluorinated alcohol was removed out of the chamber and the inside of the chamber was substituted only by the supercritical carbon dioxide. Subsequently, pressure in the chamber was reduced to an atmospheric pressure while being kept at 50° C., to dry the wafer having the photoresist film. After the drying, the wafer was observed under an electron microscope. It was confirmed that 70 nm line & space and dot pattern were maintained with no collapse. Further, swell of the photoresist was not observed in each of the patterns.

### Experimental Example 5

Photoresist “Uv2” manufactured by Shipley Co. was spin coated on a Si wafer at a number of rotation of 3000 rpm to form a photoresist film of 4000 Å thickness. Successively, after pre-baking at 130° C. for 90 sec, patterning was conducted by electron beam exposure (electron beam acceleration: 50 KeV: electron dose 10 μC/cm²).

A chip of about 1 cm² square was cut out of the wafer after patterning to prepare a test chip. Test solutions shown in Table 2 were added each by an amount capable of substantially immersing the test chip (about 1 ml) and left for 10 minutes. After 10 minutes, the test chip was taken out, rinsed with super pure water and then dried by a nitrogen blow. Presence or absence of dissolution of the photoresist with the test solution was observed by an optical microscope at 100× for the photoresist pattern before and after the supply of the test solution to the surface and absence or presence of reduction and peeling of the pattern was observed and evaluated. The result is shown in Table 2. In the table “◯” means that the photoresist was not dissolved, whereas “●” means that the photoresist was dissolved.

Further, a test chip of about 1 cm² square cut out of the patterned wafer was further baked at 140° C. for 90 sec. The test chip formed with the exposed photoresist film was subjected to a developing treatment for one minute using a liquid developer (aqueous solution of 2.38% tetramethyl ammonium hydroxide).

After development, super pure water was supplied onto the test chip to flush away the liquid developer. The test solutions shown in Table 2 were supplied gently each on the test chip to substitute the super pure water for the test solution. The test chip formed with the photoresist film was introduced into a chamber capable of supercritical treatment while keeping the state where the surface was covered with the test solution. Carbon dioxide was introduced while heating the chamber to 35° C., the pressure was increased till 10 MPa to bring the inside of the chamber into a supercritical state of carbon dioxide. Then, carbon dioxide was caused to flow for 60 minutes at a flow of 9 ml/min thereby discharging all the test solution and the inside of the chamber was substituted only with supercritical carbon dioxide. Then, the pressure in the chamber was reduced to an atmospheric pressure to obtain a dried test chip having a photoresist film.

After completion of the drying step, the test chip was taken out of the chamber and the photoresist pattern on the surface of the test chip was observed under an electron microscope to examine presence or absence of the pattern collapse. The result is shown in Table 2.

TABLE 2

| | Water substitution | Presence or absence of | Collapse |
|---|---|---|---|
| Solution | solvent proper value X | photoresist dissolution | after drying |
| HEF-7200 | 0 | ◯ | ♦ |
| FC-40 | 0 | ◯ | ♦ |
| Krytox 157 FSL | 1.3 | ◯ | — |
| 1% Krytox 157 FSL/HFE-7200 | 0.013 | ◯ | ⋄ |
| H-(CF₂)6-CH₂OH | 5.1 | ◯ | ⋄ |
| H-(CF₂)4-CH₂OH | 7.3 | ◯ | ⋄ |
| H-(CF₂)2-CH₂OH | 13 | ● | — |
| Hexafluoroisopropanol (F6IPA) | 10 | ● | — |
| 5% F6IPA/HFE-7200 | 0.50 | ◯ | ⋄ |
| 1% F6IPA/HFE-7200 | 0.10 | ◯ | ⋄ |
| 1% Perfluoro-octanoic acid/HFE 7200 | 0.079 | ◯ | ⋄ |
| Trifluoro acetic acid | 28 | ● | — |

* HFE-7200: C₄F₉OC₂H₅
* Krytox 157 FSL: Carboxylate perfluoropolyether, manufactured by Du Pont. Co.
* F6IPA: Hexafluoroisopropanol

In the table “⋄” means that the photoresist was dried with no collapse and “♦” means that the photoresist was collapsed and “-” means that drying experiment was not conducted.

What is claimed is:

1. A method of drying a microstructure with liquefied carbon dioxide or supercritical carbon dioxide, comprising the steps of:
bringing the microstructure into contact with a water-containing solvent,
substituting the water on the microstructure by a fluorocarbon type solvent having a water substitution solvent proper value X of from 0.01 to 10 defined by the following formula (1), and
bringing the microstructure into contact with liquefied carbon dioxide or supercritical carbon dioxide in a state where the microstructure is covered with the fluorocarbon type solvent which may be identical with or different from the fluorocarbon type solvent described above:
$$X = \frac{\begin{matrix}( total weight of hydrophilic portion \\ contained in functional group {R}_{x} )\end{matrix}}{( weight of fluorocarbon type solvent )} \times 100$$
[where Rₓ is one or more member selected from —OH group,
—COOH group, —NH₂ group, —C═O group and a polyethylene ether group represented by —(CH₂CH₂—O)ₙ—, in which the hydrophilic portion is OH in the —OH group, OOH in the —COOH group, NH₂ in the —NH₂ group, O in the —C═O group, and (CH₂CH₂—O)ₙ in the polyethylene ether group represented by —(CH₂CH₂—O)ₙ—] (1)

2. The drying method as defined in claim 1, which includes, after the step of substituting water on the microstructure by the fluorocarbon type solvent, a step of bringing the microstructure into contact with liquefied carbon dioxide or supercritical carbon dioxide in a state where the surface of the microstructure is covered as it is with the fluorocarbon type solvent substituting water.

3. The drying method as defined in claim 1, wherein the fluorocarbon type solvent includes a fluorocarbon type solvent having an etheric bond in the molecule.

4. The drying method as defined in any one of claim 1, wherein a hydrofluorocarbon is used as a whole or a portion of the fluorocarbon type solvent.

5. The drying method as defined in claim 1, wherein the fluorocarbon type solvent includes a fluorinated alcohol represented by a general formula: H—(CF₂)ₙ—CH₂OH.

6. A microstructure obtained by the drying method as defined in claim 1.
